(19) United States
(12) Patent Application Publication
(10) Pub. No.: US 2012/0077108 A1
(43) Pub. Date: Mar. 29, 2012

(54) FUEL CELL STACK STRUCTURE

(75) Inventor: Jongsung Kim, Hwaseong (KR)

(73) Assignee: Hyundai Motor Company, Seoul (KR)

(21) Appl. No.: 12/950,926

(22) Filed: Nov. 19, 2010

(30) Foreign Application Priority Data
Sep. 29, 2010 (KR) 10-2010-0094801

(51) Int. Cl. H01M 8/04; H01M 8/24

(52) U.S. Cl. 429/458

(57) ABSTRACT

A fuel cell stack structure comprises a first end plate, a second end plate, a plurality of fuel cells stacked between the first end plate and the second end plate, a distributor positioned near the first end plate for distributing at least one fluid toward the stacked fuel cells, a manifold having a fluid channel therein to be in fluid connection with the distributor and with the stacked fuel cells for receiving the fluid from the distributor and supplying the fluid to the stacked fuel cells, and a channel separator disposed inside the manifold in the longitudinal direction of the stacked fuel cells to separate the fluid channel of the fluid to a first space closer to the stacked fuel cells and a second space far from the stacked fuel cells. With this structure, it is possible to improve performance and durability of the fuel cell stack by uniformly supplying a fluid to the stacked fuel cells.

### CROSS-REFERENCE TO RELATED APPLICATIONS

The present application claims priority to Korean Patent Application Number 10-2010-0094801 filed Sep. 29, 2010, the entire contents of which application are incorporated herein for all purposes by this reference.

### BACKGROUND OF THE INVENTION

1. Field of the Invention

The present invention relates to a fuel cell stack structure that allows fluid to be supplied the fuel cell through a distributor.

2. Description of Related Art

A fuel cell stack is manufactured by stacking a plurality of fuel cells in a predetermined longitudinal direction in order to achieve desired output electricity. FIG. 1 is a view showing an example of a conventional fuel cell stack. As shown in FIG. 1, fuel cells 500 are stacked with both ends covered by end plates 502 and a distributor 504 are connected to the fuel cells 500 through a manifold 506 to supply fluid, such as air, hydrogen, and cooling water, to the stacked fuel cells 500.

It is preferable to simultaneously supply the same amount of fluid to all of the fuel cells 500 when supplying the fluid from the distributor 504 to the fuel cells 500; however, in the fuel cell stack having the above-described configuration, fluid is supplied to the fuel cells 500 through the manifold 506 while flowing from the distributor 504, such that the fluid may not be supplied uniformly. That is, a smaller amount of fluid is supplied to the fuel cells 500 farther from the distributor 504, while a greater amount of fluid is supplied to the fuel cells 500 closer to the distributor 504. As a result, it is difficult to generate electricity uniformly from the fuel cells 500.

In addition, in some cases, the fluid may not reach at least some of the fuel cells 500 that are relatively far from the distributor 504, thereby reducing the performance and durability of the fuel cell stack.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

An exemplary embodiment of the present invention provides a fuel cell stack structure comprising a first end plate, a second end plate, a plurality of fuel cells stacked between the first end plate and the second end plate, a distributor positioned near the first end plate for distributing at least one fluid toward the stacked fuel cells, a manifold having a fluid channel therein to be in fluid connection with the distributor and with the stacked fuel cells for receiving the fluid from the distributor and supplying the fluid to the stacked fuel cells, and a channel separator disposed inside the manifold in the longitudinal direction of the stacked fuel cells to separate the fluid channel of the fluid to a first space closer to the stacked fuel cells and a second space far from the stacked fuel cells.

With the fuel cell stack structure, it is possible to uniformly supply a fluid to stacked fuel cells, thereby improving performance and durability of a fuel cell stack.

The above and other features and advantages will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIGS. 1 and 2 are views showing a conventional fuel cell stack structure.

FIGS. 3 and 4 are views showing a fuel cell stack structure according to an exemplary embodiment of the present invention.

FIG. 5 is a view showing a channel separator of fuel cell stack structure of FIG. 3.

FIG. 6 is a graph comparing the flow rate of the conventional fuel cell stack structure with the flow rate of the fuel cell stack structure according to the present invention.

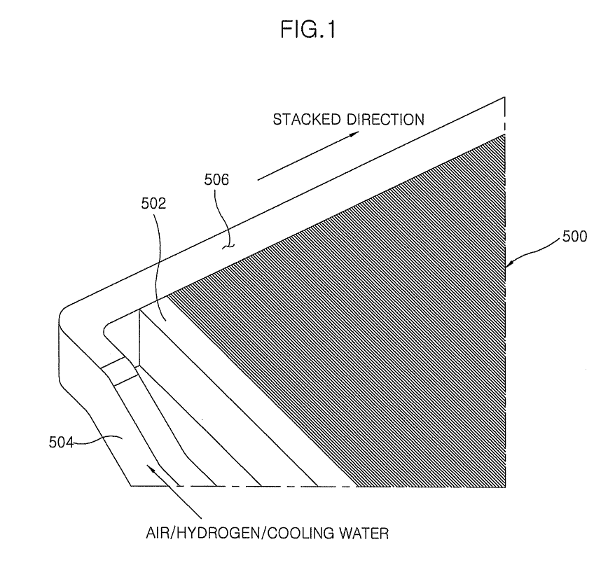

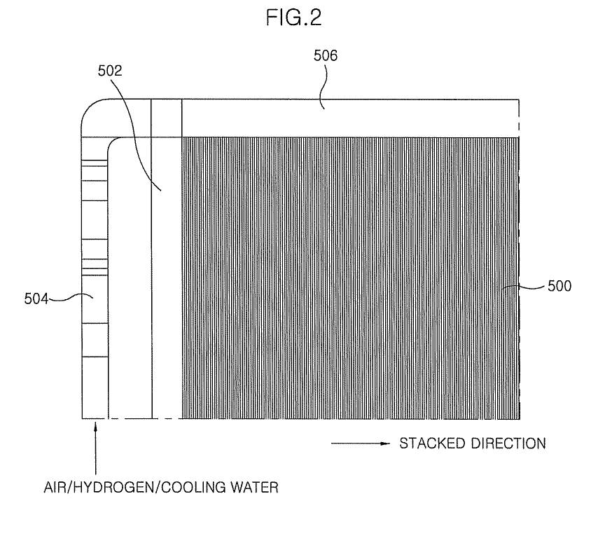

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

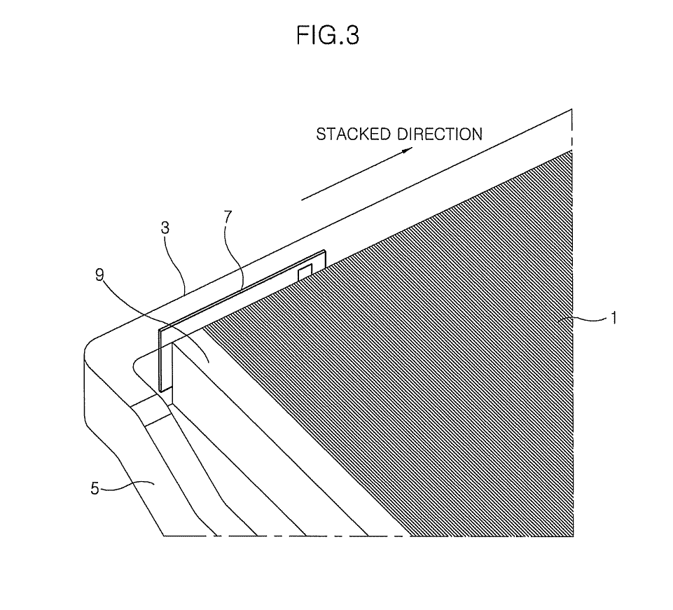

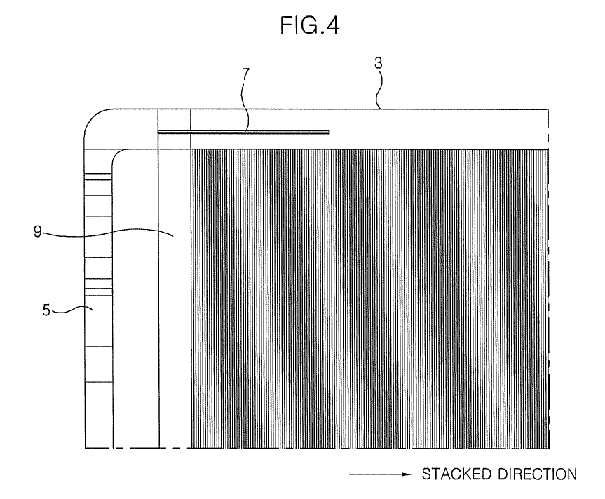

Referring to FIGS. 3 to 5, a fuel cell stack structure according to an exemplary embodiment of the present invention is configured such that fluid is supplied from a distributor 5 through a manifold 3 to a plurality of fuel cells 1 stacked in a line, in which a channel separator 7 that separates the flow paths of fluid from the distributor 5 is disposed in the manifold 3.

That is, the flow paths of the fluids, such as air, hydrogen, and cooling water, supplied to the manifold 3 from the distributor 5 through the channel separator 7 are separated such that the flow of the fluids has directionality in the stack direction of the fuel cells 1 and the fluids are supplied well to even the fuel cells 1 relatively far from the distributor 5.

The channel separator 7 is formed in a plate shape. It is disposed inside the manifold 3 in the longitudinal direction of the stacked fuel cells 1 at a predetermined position such that the space inside the manifold 3 is divided into a first space relatively close to the ends of the fuel cells and a second space relatively far from the ends of the fuel cells 1. Preferably, the channel separator 7 may be disposed at a position corresponding to a half the width of manifold 3 in the horizontal direction of the manifold 3. The channel separator 7 extends in the longitudinal direction from a position corresponding to an end plate 9 of the fuel cell stack to a position corresponding to, preferably, 25%˜35% of the entire length of the stacked fuel cells 1. With this, the flow distribution can be improved and the flow deficiency at the front part of the fuel cells can be avoided.

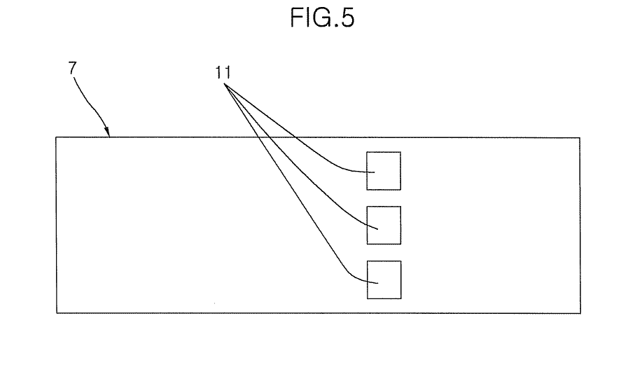

In an embodiment, the channel separator 7 includes at least one hole 11 through which the fluids can pass. Preferably, the hole or holes 11 are formed at a position that is far from the end of the channel separator 7 close to the end plate 9 by at least a distance that is a half the entire longitudinal length of the channel separator 7, as shown in FIG. 5. In case where there are at least two holes 7, the holes may be arranged in a line perpendicular to the longitudinal direction of the channel separator 7, as shown in FIG. 5. The shape of the holes are not limited to a particular one. A preferable example is a rectangular shape. With the hole(s), the flow distribution can further be improved and the flow deficiency at the front part of the fuel cells can further be avoided.

When the channel separator 7 is disposed as described above, the fluids, such as air, hydrogen, and cooling water, supplied from the distributor, can be separated by the channel separator 7. For example, a first fluid can be supplied to the fuel cells 1 relatively close to the distributor 5 through the first space and a second fluid can be supplied to the fuel cells 1 relatively far from the distributor 5 through the second space in the stacked direction of the fuel cells 1.

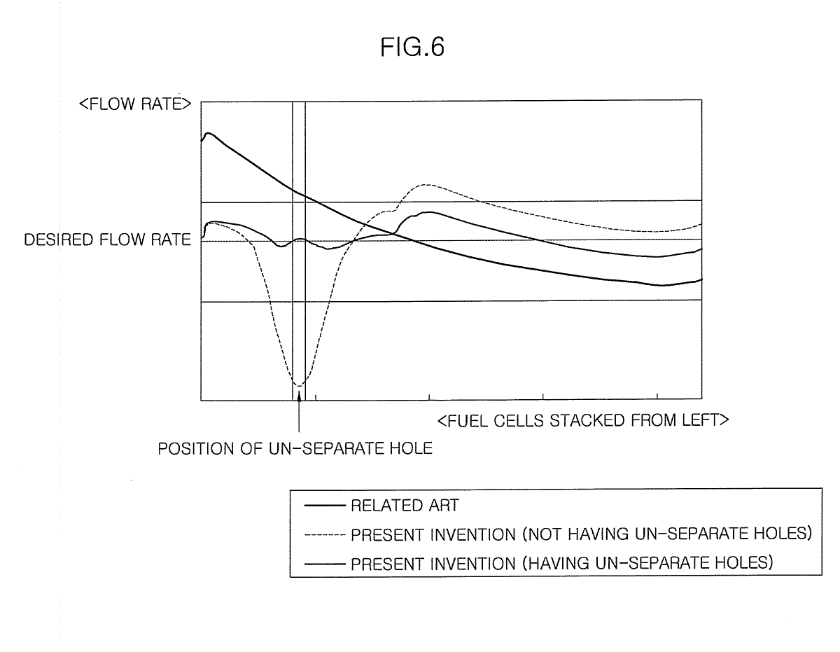

FIG. 6 shows a graph comparing the flow rate of the conventional fuel cell stack structure with the flow rate of the fuel cell stack structure according to the present invention. The horizontal axis of the graph represents the number of stacked fuel cells and the vertical axis represents the flow rate of a fluid supplied to the stacked fuel cells from a distributor. According to the graph, in case of the conventional fuel cell stack, fuel cells farther from the distributor show a flow rate smaller than a desired flow rate. On the other hand, in case of the fuel cell stack according to the embodiment of the present invention, the entire fuel cells show a relatively uniform flow rate close to a desired flow rate or fuel cells farther from the distributor show a desired flow rate or higher.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel cell stack structure comprising:
a first end plate;
a second end plate;
a plurality of fuel cells stacked between the first end plate and the second end plate;
a distributor positioned near the first end plate for distributing at least one fluid toward the stacked fuel cells;
a manifold having a fluid channel therein to be in fluid connection with the distributor and with the stacked fuel cells for receiving the fluid from the distributor and supplying the fluid to the stacked fuel cells; and
a channel separator disposed inside the manifold in the longitudinal direction of the stacked fuel cells to separate the fluid channel of the fluid to a first space closer to the stacked fuel cells and a second space far from the stacked fuel cells.

2. The fuel cell stack structure as defined in claim 1, wherein the channel separator is formed in a plate shape.

3. The fuel cell stack structure as defined in claim 2, wherein the channel separator is disposed inside the manifold and extends in the longitudinal direction of the stacked fuel cells from a position corresponding to the first end plate to a position corresponding to 25%˜35% of the entire length of the stacked fuel cells.

4. The fuel cell stack structure as defined in claim 3, wherein the channel separator is disposed at position corresponding to a half the width of the manifold.

5. The fuel cell stack structure as defined in claim 3, wherein the channel separator is provided with one or more holes through which the fluid can pass.

6. The fuel cell stack structure as defined in claim 5, wherein the hole or holes are formed at a position that is far from the first end plate by at least a distance that is a half of the entire longitudinal length of the channel separator.

7. The fuel cell stack structure as defined in claim 6, wherein the holes are arranged in a line perpendicular to the longitudinal direction of the channel separator.

8. The fuel cell stack structure as defined in claim 5, wherein the hole of holes are in a rectangular shape.
